(19) United States
(12) Patent Application Publication
(10) Pub. No.: US 2024/0209573 A1
(43) Pub. Date: Jun. 27, 2024

(54) METHOD FOR MANUFACTURING A BARRIER FILM, AND A BARRIER FILM

(71) Applicant: Stora Enso OYJ, Helsinki (FI)

(72) Inventors: Kaj Backfolk, Lappeenranta (FI); Katja Lyytikäinen, Imatra (FI); Isto Heiskanen, Imatra (FI); Tommi Nordström, Turku (FI); Anna Kauppi, Lappeenranta (FI)

(73) Assignee: Stora Enso OYJ, Helsinki (FI)

(21) Appl. No.: 18/555,326

(22) PCT Filed: Apr. 13, 2022
(86) PCT No.: PCT/IB2022/053477

§ 371 Date: Oct. 13, 2023

(30) Foreign Application Priority Data
Apr. 16, 2021 (WO) PCT/IB2021/053154

(51) Int. Cl. D21H 19/12; B29C 43/24; B29K 1/00; D21H 11/18; D21H 19/72; D21H 25/06

(52) U.S. Cl. CPC D21H 19/12; B29C 43/24; D21H 11/18; D21H 19/72; D21H 25/06; B29K 2001/00; B29K 2995/0063

(57) ABSTRACT

The present invention relates to a process for manufacturing a barrier film, wherein the method comprises:— providing an aqueous suspension comprising at least 70 weight-% highly refined cellulose pulp having an SR value of 70-95 and having a content of fibers having a length >0.2 mm of at least 10 million fibers per gram based on dry weight:— forming a wet web:— dewatering and/or drying to form a substrate:— calendering said substrate in at least one soft calender nip:— providing said substrate with at least one first layer of a barrier chemical to form a coated substrate, wherein each first layer has a coat weight of 0.5-5 gsm, and wherein a total coat weight on of the first layers is ≤8 gsm, and— drying to form said barrier film having a thickness of <50 μm. The invention relates also to a barrier film, a barrier film laminate with a polymer layer and a packaging material comprising the barrier film.

### TECHNICAL FIELD

The present disclosure relates to a method for manufacturing a barrier film, e.g. for a paper or paperboard based packaging material, which barrier film has good barrier properties, in particular water vapour barrier properties, is thin and has a low coat weight. In addition, the present disclosure relates to a barrier film, a barrier film laminate, and a paper or paperboard based packaging material comprising the barrier film or the barrier film laminate.

### BACKGROUND

Barrier films comprising cellulose fibers or polymers (cellulose-based barrier films), including films comprising high amounts of highly refined cellulose, nanocellulose or microfibrillated cellulose (MFC), are known in the art. Depending on how they are produced the cellulose-based barrier films may have particularly advantageous strength and/or barrier properties, whilst being biodegradable and recyclable (or repulpable). Such barrier films may be used in, for example, the manufacture of packaging materials and may be laminated or otherwise provided on the surface of paper or paperboard materials. Use of cellulose-based barrier films in packaging materials facilitate re-pulping and re-cycling of the used packaging materials.

However, the barrier properties of cellulose-based barrier films may be sensitive to moisture or (higher) relative humidity. In particular, the gas barrier properties of such barrier films tend to deteriorate at high temperatures and high humidity, such as when exposed to tropical conditions or conditions allowing condensation.

Many approaches for improving the barrier properties towards oxygen, air, water vapour and aromas at high relative humidity have been investigated and described, but most of the suggested solutions are expensive and difficult to implement on an industrial scale.

For example, various chemical solutions, such as coatings, lamination and surface-treatments, have been tested for improving the gas barrier properties of cellulose-based barrier films at high relative humidity.

However, difficulties may arise when providing coatings and surface treatments on cellulose-based substrates. The barrier chemicals applied as coatings on cellulose-based substrates are usually water-based solutions, dispersion or emulsions. When such water-based solutions, dispersions or emulsions are applied onto a thin cellulose-based web or substrate, the web may break or problems with dimensional stability (expansion when wetted or shrinkage when dried) may occur. This is due to water sorption and penetration into the hydrophilic substrate, affecting the hydrogen bonds between the fibrils, fibers, and the additives. Thus, web tension control may be difficult in the machine direction. Also, the web handling in the cross machine direction may be difficult.

One solution is to increase the solids of the applied solutions or dispersions, although this often leads to higher coat weight and higher viscosity of the solution. High viscosity, on the other hand, generates higher stresses on the substrates and often higher coat weights.

Another solution is to increase the basis weight of the cellulose-based web or substrate, since a higher basis weight implies a stronger material due to more fiber-fiber bonds. However, higher grammage means higher cost, a need of higher drying capacity, slower drainage (web forming) and larger reel diameter (less meter per reel when converting). Higher grammage could lead to rougher surface and/or formation of pinholes.

A further solution to reduce water sensitivity of the web is to enhance the hydrophobicity of the web by adding hydrophobizing agents to the furnish. Addition of hydrophobizing agents, might on the other hand, influence the barrier properties and might cause problems when further converting, especially if converting at high temperatures.

There are also mechanical solutions to handle the expansion/shrinkage problems, such as use of spreading rolls or shorter time between coating and drying.

For these reasons, controlling barrier chemical-substrate interaction and subsequently providing sufficient barrier properties is difficult, especially at a low coat weight and for thin substrates.

Therefore, aluminum foil and/or film-forming polymers such as thermoplastic polymers is used for these purposes and generally provides sufficient properties with regards to penetration or diffusion of oil or greases and/or aromas or gas, such as oxygen. The aluminum or certain film-forming polymers might also provide an enhanced water vapor barrier, which is important to barrier and package functionality in high relative humidity conditions or to reduce evaporation of packed liquid products.

However, one issue with the use of aluminum foil and certain film-forming polymers such as PVDC is that they pose an environmental challenge, may be a problem in the recycling process and, depending on the amount used, may lead to the material not being compostable.

Thus, there is still room for improvements of methods for producing cellulose-based barrier films, e.g. for paper or paperboard based packaging materials, which have good barrier properties such as water vapour barrier properties.

### DESCRIPTION OF THE INVENTION

It is an object of the present invention to provide an improved method for manufacturing a barrier film, e.g. for a paper or paperboard based packaging material, which barrier film has good barrier properties such as water vapour barrier properties, which method eliminates or alleviates at least some of the disadvantages of the prior art methods.

It is a further object of the present invention to provide a method for manufacturing a barrier film, e.g. for a paper or paperboard based packaging material, which is thin and is coated with a low coat weight, but still has good barrier properties, such as water vapour barrier properties, without the need of using aluminum or plastics or if being further coated with aluminum or plastics, contributing to good barrier properties.

The above-mentioned objects, as well as other objects as will be realized by the skilled person in the light of the present disclosure, are achieved by the various aspects of the present disclosure.

According to a first aspect illustrated herein, there is provided a method for manufacturing a barrier film, comprising the steps of:
providing an aqueous suspension comprising at least 70 weight-% highly refined cellulose pulp based on total dry weight of the aqueous suspension, wherein said highly refined cellulose pulp has a Schopper-Riegler value (°SR) of 70-95° SR, and wherein said highly refined cellulose pulp has a content of fibers having a length >0.2 mm of at least 10 million fibers per gram based on dry weight
forming a wet web from said aqueous suspension;
dewatering and/or drying said wet web to form a substrate having a first side and an opposite second side;
calendering said substrate in at least one soft calender nip in a first calendering step, wherein said substrate has a moisture content of 1-25 weight-% when entering the first calendering step;
providing said substrate with at least one first layer of:
a) a water-based solution or dispersion comprising a polymer selected from the group consisting of: a polyvinyl alcohol, a modified polyvinyl alcohol, a polysaccharide or a modified polysaccharide, or combinations thereof, or
b) a water-based emulsion comprising a latex, or
c) a combination of a) and b), on said first side in a first coating step to form a coated substrate, wherein each first layer has a coat weight of 0.5-5 gsm, preferably 0.5-3 gsm, calculated as dry weight, and wherein a total coat weight on the first side is equal to or less than 8 gsm calculated as dry weight,
drying said coated substrate after said first calendering step and said first coating step so as to form said barrier film, wherein said barrier film has a thickness of less than 50 μm, preferably less than 45 μm, most preferably less than 40 μm.

It has surprisingly been found that by using at least 70 weight-% of the herein specified highly refined cellulose pulp, based on total dry weight of the aqueous suspension, for forming a substrate and by calendering the substrate in at least one soft calender nip in a first calendering step, wherein the substrate has a moisture content of 1-25 weight-% when entering the first calendering step, it is possible to provide the substrate with a low coat weight on at least one side when using a water-based solution or dispersion or emulsion of a barrier chemical selected from groups a)-c) above and obtain a thin barrier film with good barrier properties, in particular water vapour barrier properties, on at least one side. In addition, it was surprisingly found that the runnability in the coating process may be significantly improved when the coating process is applied after the soft calendering, i.e. problems with web breaks and problems with dimensional stability may be significantly reduced.

In particular, it was surprisingly found that calendering the above specified substrate in one soft calender nip at the specified moisture content, in combination with use of at least 70 weight-% highly refined cellulose pulp, based on total dry weight of the aqueous suspension, for forming the substrate, may be enough to enable providing the substrate with a low coat weight of a barrier chemical selected from group a) or b) or c) above on at least one side and obtain a thin barrier film with good barrier properties, in particular water vapour barrier properties, on at least one side.

When water-based solutions, dispersions or emulsions are applied onto a thin cellulose-based web or substrate, the web may break or problems with dimensional stability (expansion when wetted or shrinkage when dried) may occur. This is due to water sorption and penetration into the hydrophilic substrate, affecting the hydrogen bonds between the fibrils, fibers, and the additives. Thus, web tension control may be difficult in the machine direction. Also, the web handling in the cross machine direction may be difficult. One previously known solution is to increase solids of the applied solutions, although this often leads to higher coat weight and higher viscosity of the solution. High viscosity, on the other hand, generates higher stresses on the substrates and often higher coat weights. Another previously known solution is to increase the basis weight of the cellulose-based web or substrate, since a higher basis weight implies a stronger material due to more fiber-fiber bonds. However, higher bulk means increased roughness and larger reel diameter (less meter per reel when converting).

Thus, it has surprisingly been found that by using at least 70 weight-% of the herein specified highly refined cellulose pulp, based on total dry weight of the aqueous suspension, for forming a substrate and by calendering the substrate in at least one soft calender nip in a first calendering step at a moisture content of 1-25 weight-% when entering the first calendering step, it is enabled to avoid using a high amount of coating and/or to avoid using a high viscosity (where high viscosity means >5000 mPas at 23° C., e.g. as measured with a Brookfield rotational viscosimeter) of the applied barrier chemical solution/dispersion/emulsion when using a barrier chemical selected from group a) or b) or c) above and/or to avoid increasing the basis weight of the substrate in order to obtain a thin barrier film with good barrier properties, in particular water vapor barrier properties. Use of special or complex mechanical solutions to reduce the problems with web breaks and problems with dimensional stability may also be avoided or limited. Further advantages are that better coating hold-out and less penetration into the web may be achieved.

The soft calendering of the substrate at a moisture content of 1-25 weight-% implies that a densification on the calendered side is achieved, preferably to close the surface, whereby use of a low coat weight with a higher coverage is facilitated. In addition, the densification by means of the soft calendering of the substrate at a moisture content of 1-25 weight-% might also allow for a better shrinkage profile when dried (less and more even shrinkage) and/or better expansion profile when wetted (less and more even expansion).

The term barrier film as used herein generally refers to a thin continuous sheet formed material with low permeability for gases and/or liquids. Depending on the composition of the pulp suspension, the film can also be considered as a thin paper or even as a membrane, e.g. for selective control of flux of components or gases.

The barrier film can be used as such, or it can be combined with one or more other layers. The film is for example useful as a barrier layer in a paper or paperboard based packaging material. The barrier film may also be or constitute a barrier layer in a multiply product comprising a base such as glassine, greaseproof paper, barrier paper or bioplastic films. Alternatively, the barrier film can be comprised in at least one layer in a multiply sheet such as a liquid packaging board.

The term barrier chemical as used herein refers to a chemical applied as coating or surface treatment to a substrate for improving at least one barrier property, e.g. water vapor barrier property.

Paper generally refers to a material manufactured in thin sheets from the pulp of wood or other fibrous substances comprising cellulose fibers, used for writing, drawing, or printing on, or as packaging material.

Paperboard generally refers to strong, thick paper or cardboard comprising cellulose fibers used for boxes and other types of packaging. Paperboard can either be bleached or unbleached, coated or uncoated, and produced in a variety of thicknesses, depending on the end use requirements.

A paper or paperboard-based packaging material is a single or multiply packaging material formed mainly, or entirely from paper or paperboard. In addition to paper or paperboard, the paper or paperboard-based packaging material may comprise additional layers or coatings designed to improve the performance and/or appearance of the packaging material.

As mentioned above, the method of the first aspect of the present disclosure comprises a step of providing an aqueous suspension comprising at least 70 weight-% highly refined cellulose pulp based on total dry weight. Refining, or beating, of cellulose pulps refers to mechanical treatment and modification of the cellulose fibers in order to provide them with desired properties.

The highly refined cellulose pulp used in the method of the first aspect has a Schopper Riegler value (° SR) of 70-95, preferably in the range of 70-92, more preferably in the range of 75-92, most preferably in the range of 75-90 or 80-90 or 85-90, as determined by standard ISO 5267-1. The SR value is determined for a pulp without additional chemicals, thus the fibers have not consolidated into a film or started e.g. hornification.

In addition, the highly refined cellulose pulp used in the method of the first aspect has a content of fibers having a length >0.2 mm of at least 10 million fibers per gram based on dry weight, preferably at least 12 million fibers per gram based on dry weight, more preferably at least 15 million fibers per gram based on dry weight, even more preferably at least 17 million fibers per gram based on dry weight. The content of fibers having a length >0.2 mm may for example be determined using the L&W Fiber tester Plus (L&W/ABB) instrument (also referred herein to as “Fiber Tester Plus”). For example, fibers may be defined as fibrous particles longer than 0.2 mm according to standard ISO 16065-2.

Furthermore, in some embodiments, the highly refined cellulose pulp used in the method of the first aspect has a mean fibril area of fibers having a length >0.2 mm of at least 15%, preferably at least 17%, more preferably at least 20%. The mean fibril area is determined using the L&W Fiber Tester Plus (L&W/ABB) instrument, e.g. with definition of fibers as fibrous particles longer than 0.2 mm according to standard ISO 16065-2. “Mean fibril area” as used herein refers to length weighted mean fibril area.

In some embodiments, the highly refined celluose pulp used in the method of the first aspect has a water retention (WRV) value of ≥250%, more preferably ≥300%. In addition, the WRV value is preferably ≤400%, more preferably ≤380% or ≤370% or ≤350%. In some embodiments, the highly refined cellulose pulp used in the method of the first aspect has a WRV value of 250-400%, or 250-380%, or 250-350%, or 300-350%. The WRV value may be determined by standard ISO 23714 with the use of a 200 mesh wire.

The highly refined cellulose pulp used in the method of the first aspect can be produced in many different ways using methods known in the art to achieve the desired Schopper-Riegler value and content of fibers having a length >0.2 mm and optionally the desired mean fibril area and WRV value.

As mentioned above, the aqueous suspension used in the method of the first aspect comprises at least 70 weight-%, more preferably at least 75 weight-%, most preferably at least 80 weight-%, at least 85 weight-% or at least 90 weight-% of highly refined cellulose pulp based on total dry weight of the aqueous suspension. In some embodiments, the aqueous suspension comprises highly refined cellulose pulp in the range of 70-99 weight-%, more preferably in the range of 75-99 weight-%, most preferably in the range of 80-99 weight-% or 85-99 weight-% or 90-99 weight-%, based on the total dry weight of the aqueous suspension.

In some embodiments, the aqueous suspension further comprises one or more further cellulose pulp fractions in addition to the highly refined cellulose pulp, which one or more further cellulose pulp fractions have been refined to different refining degrees than the highly refined cellulose pulp or have been co-refined with the highly refined cellulose pulp. In some embodiments, the aqueous suspension comprises a further cellulose pulp fraction of moderately refined cellulose pulp having a Schopper-Riegler value of ≤ 50° SR, such as 15-50° SR or 20-40° SR, as determined by standard ISO 5267-1, and/or a further fraction of normal fibers. The aqueous suspension may comprise, for example, 1-30 weight-%, more preferably 2-30 weight-%, most preferably 5-30 weight-% of further cellulose pulp fractions, based on the total dry weight of highly refined cellulose pulp and further cellulose pulp fraction(s) (i.e. based on the total dry weight of total amount of fibers in the aqueous suspension).

By normal fibers is meant normal pulp fibers of a conventional length and fibrillation for papermaking. Normal fibers may include mechanical pulp, thermochemical pulp, chemical pulp such as sulphate (kraft) or sulphite pulp, dissolving pulp, recycled fiber, organosolv pulp, chemi-thermomechanical pulp (CTMP), or combinations thereof. Normal fibers may alternatively or additionally include semichemical pulp. The pulp may be bleached or unbleached. The normal fibers can be vegetable fibers, such as wood derived (e.g. hardwood or softwood) or agricultural sources including straw, bamboo, etc.

The normal fibers may have a beating degree, i.e. Schopper-Riegler value, in the range of 15 to 50° SR, or more preferably in the range of 18 to 40°SR, as determined by standard ISO 5267-1. The normal fibers may preferably be chemical pulp, such as kraft pulp.

The normal fibers may have an average length in the suspension of 1 mm to 5 mm, more preferably in the range of 2 to 4 mm.

The highly refined cellulose pulp and the optional moderately refined cellulose pulp used in the method of the first aspect may for example be produced from softwood or hardwood or a mix thereof, such as 5-95, 10-90, 15-95, 20-80 or 25-75 (weight-% softwood—weight-% hardwood). It can also be made from microbial sources, agricultural fibers such as wheat straw pulp, bamboo, bagasse, or other non-wood fiber sources. It can also be made from broke or recycled paper. For example, the highly refined cellulose pulp may be produced from mechanical pulp, thermochemical pulp, chemical pulp such as sulphate (kraft) or sulphite pulp, dissolving pulp, organosolv pulp or chemi-thermomechanical pulp (CTMP), or combinations thereof. Preferably, the cellulose fiber material is chemical pulp, such as kraft pulp. The pulp is preferably delignified and processed according to known methods in the art. One preferred source of fiber is an ECF or TCF bleached kraft pulp.

The aqueous suspension may comprise microfibrillated cellulose (MFC). In some embodiments, the aqueous suspension comprises ≤10 weight-%, preferably ≤8 weight-%, more preferably ≤5 weight-%, of MFC based on total dry weight of the aqueous suspension. In some embodiments, the aqueous suspension comprises 1-10 weight-%, or 1-8 weight-% or 1-5 weight-% MFC based on total dry weight of the aqueous suspension.

Microfibrillated cellulose (MFC) shall in the context of this patent application mean a cellulose particle, fiber or fibril having a width or diameter of from 20 nm to 1000 nm.

Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into MFC.

MFC can be produced from wood cellulose fibers, both from hardwood or softwood fibers. It can also be made from microbial sources, agricultural fibers such as wheat straw pulp, bamboo, bagasse, or other non-wood fiber sources. It can be made from pulp, including pulp from virgin fiber, e.g. mechanical, chemical and/or thermomechanical pulps. It can also be made from broke or recycled paper.

The aqueous suspension may in addition to highly refined cellulose pulp and optional further pulp fraction(s) comprise any conventional paper making additives or chemicals such as fillers, pigments, wet strength chemicals, retention chemicals, cross-linkers, softeners or plasticizers, adhesion primers, wetting agents, biocides, optical dyes, colorants, fluorescent whitening agents, de-foaming chemicals, hydrophobizing chemicals such as AKD, ASA, waxes, resins, bentonite, stearate, wet end starch, silica, precipitated calcium carbonate, cationic polysaccharide, etc. These additives or chemicals may thus be process chemicals or film performance chemicals added to provide the end product film with specific properties and/or to facilitate production of the film. Preferably, the aqueous suspension comprises no more than 20 weight-%, more preferably no more than 10 weight-% of additives, based on total dry weight of the aqueous suspension. For example, the aqueous suspension may comprise 1-20 weight-% or 1-10 weight-% of additives, based on total dry weight of the aqueous suspension.

As mentioned above, the method of the first aspect comprises a step of forming a wet web from the aqueous suspension. The wet web may be formed by, for example, wet laid techniques, such as e.g. a papermaking process, or at least a modified papermaking process. These processes may include wet wire formation on a wire. Preferably, the wet web is formed on a porous support such as a porous wire.

In a wire forming technique a pulp suspension is provided and dewatered on a porous surface to form a fibrous wet web. A suitable porous surface is e.g. porous wire in e.g. a paper machine. The wet web is then dried and/or further dewatered in e.g. a drying section in a paper machine to form a substrate.

Thus, the wet web may be formed in a papermaking machine such as a fourdrinier or other forming types such as Twin-former or hybrid former. The web can be single or multilayer web or single ply or multiply web, made with one or several headboxes.

As mentioned above, the method of the first aspect comprises a step of dewatering and/or drying the wet web to form a substrate having a first side and an opposite second side (i.e. a second side facing away from the first side). The dewatering and/or drying may be performed by any conventional techniques, such as press dewatering, hot air drying, contacting it with hot or warm cylinder or metal belt, irradiation drying or through vacuum, etc.

When the wet web is formed by the wet laid method, the wet web formed on a porous wire is dewatered through the wire and optionally also by press dewatering in a subsequent press section.

In some embodiments, the substrate obtained in the step of dewatering and/or drying (i.e. before the first calendering step and the first coating step) has a density of 600-950 kg/m³, preferably 650-900 kg/m³, most preferably 700-850 kg/m³. Thus, in some embodiments the substrate has a density of 600-950 kg/m³, preferably 650-900 kg/m³, most preferably 700-850 kg/m³ when entering the first calendering step.

In some embodiments, the basis weight of the substrate obtained in the step of dewatering and/or drying (i.e. before the first calendering step and the first coating step), is less than 90 g/m², more preferably less than 80 g/m², most preferably less than 75 or less than 70 or less than 65 or less than 40 g/m², but higher than 15 g/m².

Preferably, the first calendering step and/or the first coating step are carried out on-line after the step of dewatering and/or drying. However, the first calendering step and/or the first coating step may also be carried out in a machine and/or location different from that of the step of dewatering and/or drying (i.e. the first calendering step and/or the first coating step may be performed off-line).

In some embodiments, the Gurley Hill porosity value of the substrate obtained in said step of dewatering and/or drying said wet web (i.e. after having performed said step of dewatering and/or drying) is at least 20000 s/100 m¹, typically at least 25000 s/100 m¹, or at least 30000 s/100 m¹. The Gurley Hill value can be determined using the standard method ISO 5636-5, wherein the max value is 42300 s/100 m¹. Other devices might have other max values and use other standards.

As mentioned above, the method of the first aspect comprises calendering the substrate in at least one soft calender nip in a first calendering step.

The term “soft calender” (or “soft nip calender”) is herein intended to mean a calender having a soft roll cover on at least one of its two nip rolls. Thus, one of the two rolls may be a soft roll and the other roll a hard roll (which hard roll is optionally heated). Alternatively, both rolls may be soft rolls.

The term “soft calender nip” is herein intended to mean a nip in a calender between a soft roll and a hard roll, or between two soft rolls. The soft calender nip may be comprised in a soft calender or a multi-nip calender.

The term “hard calender nip” is herein intended to mean a nip in a calender having two hard rolls as the two nip rolls. The hard calender nip may be comprised in a hard calender or in a multi-nip calender. A hard calender nip may be a machine calender nip.

The substrate may be calendered in the first calendering step in one soft calender nip comprising one soft roll and one hard roll. Alternatively, the substrate may be calendered in the first calendering step in one soft calender nip comprising two soft rolls. Still alternatively, the substrate may be calendered in the first calendering step in two or more soft calender nips, wherein all soft calender nips comprise one soft roll and one hard roll. In a further alternative, the substrate may be calendered in the first calendering step in two or more soft calender nips, wherein all soft calender nips comprise two soft rolls. In another alternative, the substrate may be calendered in the first calendering step in two or more soft calender nips, wherein the two or more soft calender nips are constituted by one or more soft calender nip having one soft roll and one hard roll and one or more soft calender nip having two soft rolls.

In some embodiments comprising one soft calender nip, the soft calender nip comprises a soft roll and a hard roll, wherein the soft roll or the hard roll may be positioned against the first side of the substrate. Preferably, the hard roll is positioned against the first side of the substrate in these embodiments.

In some embodiments comprising two or more soft calender nips, all soft calender nips comprise a soft roll and a hard roll. At least one hard roll may then be positioned against the first side of the substrate. Alternatively, all hard rolls are positioned against the first side of the substrate.

Preferably, at least one hard roll of the at least one soft calender nip of the first calendering step is positioned against the first side of the substrate.

As mentioned above, the moisture content of the substrate is 1-25 weight-%, preferably 2-20 weight-%, more preferably 3-15 weight-%, when entering the first calendering step, such as when entering the first soft calender nip.

The mentioned moisture content of the substrate in the first calendering step may be provided, or essentially provided, in the step of dewatering and/or drying. Alternatively, the method may further comprise a step of pre-moisturizing the substrate prior to the first calendering step. It may also be possible to add moisture during the first calendering step. The pre-moisturizing may be performed by using steam or water with or without chemicals. In some embodiments, 1-15 g/m², preferably 2-10 g/m², most preferably 2.5-8 g/m², steam or water is applied. In some embodiments, the temperature may be increased by at least 10° C., or at least 20° C. during pre-moisturizing with steam or water. Thereby, the substrate may be easier to plasticize and restructure during the calendering.

As mentioned above, the method of the first aspect comprises providing the substrate with at least one first layer of:
a) a water-based solution or dispersion comprising a polymer selected from the group consisting of: a polyvinyl alcohol, a modified polyvinyl alcohol, a polysaccharide or a modified polysaccharide, or combinations thereof, or
b) a water-based emulsion comprising a latex, or
c) a combination of a) and b) on the first side in a first coating step to form a coated substrate.

Thus, in the first coating step the substrate is provided with one or more first layers of a water-based solution/dispersion/emulsion of a barrier chemical selected from group a) or b) or c) above. Each first layer har a coat weight of 0.5-5 gsm, preferably 0.5-3 gsm, more preferably 1-2.5 gsm, calculated as dry weight. The total coat weight of the one or more first layer on the first side is equal to or less than 8 gsm, preferably equal to or less than 6 gsm, most preferably equal to or less than 5 gsm calculated as dry weight.

In some embodiments, the method of the first aspect further comprises providing said substrate with at least one second layer of the water-based solution or dispersion selected from group a) above or the water-based emulsion selected from group b) above or a combination of group c) above on the second side in a second coating step. Each second layer has a coat weight of 0.5-5 gsm, preferably 0.5-3 gsm, more preferably 1-2.5 gsm, calculated as dry weight. In these embodiments, the total coat weight of the at least one first layer on the first side is equal to or less than 5 gsm calculated as dry weight and the total coat weight of the at least one second layer on the second side is equal to or less than 5 gsm calculated as dry weight.

Each first layer may be continuous or non-continuous and may have the same or different thickness at different locations on the first side of the substrate.

Each second layer may be continuous or non-continuous and may have the same or different thickness at different locations on the second side of the substrate.

For example, a non-continuous layer may have a degree of coverage of the substrate of at least 60% or 70% or 80%.

The first layer(s) and the second layer(s) may be applied by contact or non-contact coating methods. Examples of useful coating methods include, but are not limited to, rod coating, curtain coating, film press coating, cast coating, transfer coating, size press coating, flexographic coating, gate roll coating, twin roll HSM coating, blade coating, such as short dwell time blade coating, jet applicator coating, spray coating, gravure coating or reverse gravure coating. In some embodiments, at least one layer is applied in the form of a foam.

The polyvinyl alcohol (PVOH) of group a) above may be a single type of PVOH, or it can comprise a mixture of two or more types of PVOH, differing e.g. in degree of hydrolysis or viscosity. The PVOH may for example have a degree of hydrolysis in the range of 80-99 mol %, preferably in the range of 85-99 mol %. Furthermore, the PVOH may preferably have a viscosity above 5 mPaxs in a 4% aqueous solution at 20° C. DIN 53015/JIS K 6726 (with no additives and with no change in pH, i.e. as obtained when dispersed and dissolved e.g. in distilled water). Examples of useful products are, e.g. Kuraray Poval 15-99, Poval 4-98, Poval 6-98, Poval 10-98, Poval 20-98, Poval 30-98, or Poval 56-98 or mixtures of these. From the less hydrolyzed grades, the Poval 4-88, Poval 6-88, Poval 8-88, Poval 18-88, Poval 22-88, or e.g. Poval 49-88 are preferred. The PVOH can also be modified with alkyl substituents such as ethylene groups, or anionic groups such as carboxylic acid groups, or other functional groups such as cationic or silanol groups. The PVOH may be washed or be of a low ash content grade.

The polysaccharide of group a) above may be, for example, starch.

The modified polysaccharide of group a) above may be, for example, a modified cellulose, such as carboxymethylcellulose (CMC), hydroxypropyl cellulose (HPC), ethylhydroxyethyl cellulose (EHEC) or methyl cellulose, or a modified starch, such as a hydroxyalkylated starch, a cyanoethylated starch, a cationic or anionic starch, or a starch ether or a starch ester. Another example of a modified cellulose is sodium carboxymethylcellulose. Some preferred modified starches include hydroxypropylated starch, hydroxyethylated starch, dialdehyde starch and carboxymethylated starch.

The latex of group b) above may selected from the group comprising styrene-butadiene latex, styrene-acrylate latex, acrylate latex, vinyl acetate latex, vinyl acetate-acrylate latex, styrene-butadiene-acrylonitrile latex, styrene-acrylate-acrylonitrile latex, styrene-butadiene-acrylate-acrylonitrile latex, styrene-maleic anhydride latex, styrene-acrylate-maleic anhydride latex, or a mixture of these latexes. The latex is preferably a styrene-butadiene (SB) latex or a styrene-acrylate (SA) latex, or a mixture of these latexes. The latex can be biobased, i.e. derived from biomass, such as biobased styrene-acrylate or styrene-butadiene latex. Biobased latex can provide similar performance, and provides improved carbon footprint. In some embodiments, the latex is selected from styrene-butadiene (SB) latex, styrene-acrylate (SA) latex, or a mixture thereof.

In some embodiments, the substrate is provided with at least one first layer of a water-based solution or dispersion comprising polyvinyl alcohol in the first coating step. In some embodiments, the substrate is provided with at least one second layer of a water-based solution or dispersion comprising polyvinyl alcohol in the second coating step.

In some embodiments, the substrate is provided with at least one first layer of a water-based emulsion comprising styrene-acrylate latex in the first coating step. In some embodiments, the substrate is provided with at least one second layer of a water-based emulsion comprising styrene-acrylate latex in the second coating step.

In some embodiments, the first calendering step is performed before the first coating step.

In some embodiments, the substrate is calendered in one soft calender nip in the first calendering step, wherein the soft calender nip comprises one soft roll and one hard roll, wherein the soft roll or the hard roll is positioned against the first side of the substrate and wherein the first coating step is performed after the first calendering step. Thus, in these embodiments, the first side of the substrate is positioned against the soft roll or the hard roll in the first calendering step and the calendered first side is then provided with at least one first layer in the first coating step. Preferably, the hard roll is positioned against the first side of the substrate. These embodiments may optionally comprise the above mentioned second coating step, in which the substrate is provided with at least one second layer on the second side. The second coating step may be performed after the first coating step or essentially simultaneously as the first coating step.

It was surprisingly found that it was possible to perform the first calendering step before the first coating step and still obtain a thin barrier film with good barrier properties. In particular, it was surprisingly found that the thickness increase of the substrate was small when providing a barrier chemical from group a) or b) or c) above in spite of the fact that the substrate was (soft) calendered before the barrier chemical application.

In some embodiments, the substrate is calendered in one or more soft calender nips in the first calendering step, wherein each soft calender nip comprises two soft rolls, wherein the first coating step is performed after said first calendering step. These embodiments may optionally comprise the above mentioned second coating step, in which the substrate is provided with at least one second layer on the second side. The second coating step may be performed after the first coating step or essentially simultaneously as the first coating step.

In some embodiments, the substrate is calendered in two or more soft calender nips in the first calendering step, wherein each soft calender nip comprises one soft roll and one hard roll, wherein the hard roll of at least one soft calender nip is positioned against the first side of the substrate and wherein the first coating step is performed after said first calendering step. These embodiments may optionally comprise the above mentioned second coating step, in which the substrate is provided with at least one second layer on the second side. The second coating step may be performed after the first coating step or essentially simultaneously as the first coating step.

In some embodiments, the substrate is calendered in two or more soft calender nips in the first calendering step, wherein the two or more soft calender nips are constituted by one or more soft calender nip having one soft roll and one hard roll and one or more soft calender nip having two soft rolls and wherein the first coating step is performed after said first calendering step. These embodiments may optionally comprise the above mentioned second coating step, in which the substrate is provided with at least one second layer on the second side. The second coating step may be performed after the first coating step or essentially simultaneously as the first coating step.

In embodiments in which the first calendering step is performed before the first coating step, the method may further comprise a second calendering step after the first coating step. The second calendering step may comprise calendering the coated substrate in at least one second calender selected from a soft calender, a hard/machine calender, a super calender, a shoe-nip calender, a metal-belt calender and a multi-nip calender. The multi-nip calender can be, for example, a Janus calender, optiload calender or Prosoft calender. The second calender can also be a special calender such as wet stack calender, breaker stack calender or friction calender. These embodiments may optionally comprise the above mentioned second coating step, in which the substrate is provided with at least one second layer on the second side. The second coating step may be performed essentially simultaneously as the first coating step. Alternatively, the second coating step may be performed after the first coating step but before the second calendering step. Still alternatively, the second coating step may be performed after the second calendering step.

In some embodiments, the first coating step is performed before said first calendering step. Optionally, these embodiments may comprise a second calendering step after the first calendering step, wherein the second calendering step may comprise calendering the coated substrate in at least one second calender selected from the above group of second calenders.

In some embodiments, the substrate is calendered in one soft calender nip in the first calendering step, wherein the soft calender nip comprises one soft roll and one hard roll, wherein the soft roll or the hard roll is positioned against the first side of the substrate and wherein the first coating step is performed before the first calendering step. Thus, in these embodiments, the first side of the substrate is provided with at least one layer in the first coating step and the coated first side is then positioned against the soft roll or the hard roll in the first calendering step. Preferably, the hard roll is positioned against the first side of the substrate. These embodiments may optionally comprise the above mentioned second coating step, in which the substrate is provided with at least one second layer on the second side. The second coating step may be performed essentially simultaneously as the first coating step. Alternatively, the second coating step may be performed after the first coating step and be performed before or after the first calendering step.

In some embodiments, the substrate is calendered in one or more soft calender nip in the first calendering step, wherein each soft calender nip comprises two soft rolls, wherein the first coating step is performed before said first calendering step. These embodiments may optionally comprise the above mentioned second coating step, in which the substrate is provided with at least one second layer on the second side. The second coating step may be performed essentially simultaneously as the first coating step. Alternatively, the second coating step may be performed after the first coating step and be performed before or after the first calendering step.

In some embodiments, the substrate is calendered in two or more soft calender nips in the first calendering step, wherein each soft calender nip comprises one soft roll and one hard roll, wherein the hard roll of at least one soft calender nip is positioned against the first side of the substrate and wherein the first coating step is performed before said first calendering step. These embodiments may optionally comprise the above mentioned second coating step, in which the substrate is provided with at least one second layer on the second side. The second coating step may be performed essentially simultaneously as the first coating step. Alternatively, the second coating step may be performed after the first coating step and be performed before or after the first calendering step.

In some embodiments, the substrate is calendered in two or more soft calender nips in the first calendering step, wherein the two or more soft calender nips are constituted by one or more soft calender nip having one soft roll and one hard roll and one or more soft calender nip having two soft rolls and wherein the first coating step is performed before said first calendering step. These embodiments may optionally comprise the above mentioned second coating step, in which the substrate is provided with at least one second layer on the second side. The second coating step may be performed essentially simultaneously as the first coating step. Alternatively, the second coating step may be performed after the first coating step or be performed before or after the first calendering step.

In some embodiments, the method of the first aspect comprises a pre-calendering step before the first calendering step. The pre-calendering step may be performed in, for example, a hard calender nip.

As mentioned above, the method of the first aspect comprises a step of drying the coated substrate after the first calendering step and the first coating step so as to form the barrier film. In embodiments comprising one or more further calendering steps (such as the above mentioned second calendering step) and/or one or more further coating steps (such as the above mentioned second coating step), the step of drying is performed after the further calendering step(s) and the further coating step(s). Preferably, the drying is performed so that the temperature of the substrate is >80° C. and preferably >85° C. for facilitating film forming.

The formed barrier film has a thickness of less than 50 μm, preferably less than 45 μm, most preferably less than 40 μm or less than 38 μm or less than 35 μm or less than 32 μm, but more than 15 μm. The thickness may be determined according to ISO 534. The grammage of the formed barrier film (i.e. of the substrate after coating and drying) may be 20-90 g/m², preferably 25-80 g/m², most preferably 28-65 g/m². The grammage may be determined according to ISO 536. In some embodiments, the grammage of the formed barrier film may be 20-90 g/m², preferably 25-80 g/m², most preferably 28-65 g/m² and the ratio of coating grammage to substrate grammage may be in the range of 0.8:100-30:100, more preferably 1:100-15:100 for barrier films with grammage below 40 g/m², and 0.6:100-25:100, more preferably 1:100-12:100 for barrier films with grammage above 40 g/m².

The step of drying the coated substrate can for example be performed by using hot air, IR radiation, or a combination thereof. The coated substrate can also be further dried and cured in e.g. contact or non-contact driers selected from the group consisting of: cylinder drying apparatus, yankee dryer, single tier dryer, steam dryer, air impingement dryer, impulse drying apparatus, microwave drying apparatus, Condebelt, belt nip dryer, through air dryer (TAD). Alternatively, the step of drying can be performed in a calender, e.g. by combining hot air and/or radiation dryer with calender.

In some embodiments, the first calendering step comprises using a line load of up to 500 kN/m, preferably 20-250 KN/m.

In some embodiments, the first calendering step is performed at a temperature of 50-250° C., preferably 80-180° C., in the at least one soft calender nip. The rolls of the soft calender nip may have the same or different temperatures. A soft roll of a soft calender nip is often not heated but warms up during running.

In some embodiments, the machine speed is at least 50 m/min, preferably at least 100 m/min, more preferably 150 or 200 or 250 or 300 or 400 or 500 m/min, most preferably at least 550 m/min, but less than 1700 m/min.

In some embodiments, the Cobb Unger absorption value of the obtained barrier film is less than 1.5 g/m² (30 s), preferably less than 1.4 or 1.3 or 1.2 or 1.1 g/m² (30 s), for a coated side (i.e. for the first side and for the second side in embodiments of coating both sides). Cobb Unger is determined according to SCAN-P 37:77.

In some embodiments, the obtained barrier film has a water vapor transmission rate (WVTR), measured according to the standard ASTM F1249 at 50% relative humidity and 23° C., of less than 50 g/m²/day, preferably less than 35 g/m²/day, more preferably less than 20 g/m²/day, most preferably less than 15 g/m²/day, even more preferably less than 10 g/m²/day (for a coated side).

In some embodiments, the substrate has a PPS roughness of >2 μm or >3 μm or >4 μm before the first calendering step. In some embodiments, the substrate has a PPS roughness of >1 μm but <5 μm after the first calendering step. In some embodiments, the substrate has a PPS roughness of >1 μm but <5 μm after the first calendering step and the first coating step. PPS 1.0 MPa smoothness is determined with ISO 8791-4

In some embodiments, the barrier film has an oxygen transmission rate (OTR), measured according to the standard ASTM D-3985 at 50% relative humidity and 23° C., of less than 500 cc/m²/day, preferably less than 250 cc/m²/day, more preferably less than 100 cc/m²/day, even more preferably less than 50 cc/m²/day (for a coated side).

The inventive barrier film will typically exhibit good resistance to grease and oil. Grease resistance of the barrier film is evaluated by the KIT-test according to standard ISO 16532-2. The test uses a series of mixtures of castor oil, toluene and heptane. As the ratio of oil to solvent is decreased, the viscosity and surface tension also decrease, making successive mixtures more difficult to withstand. The performance is rated by the highest numbered solution which does not darken the film sheet after 15 seconds. The highest numbered solution (the most aggressive) that remains on the surface of the paper without causing failure is reported as the “kit rating” (maximum 12). In some embodiments, the KIT value of the barrier film is at least 10, preferably 12, as measured according to standard ISO 16532-2.

There is a demand for improved solutions to replace aluminum foils and polyolefin films as barrier layers in packaging materials, such as liquid packaging board, with alternatives that facilitate re-pulping and recycling of the used packaging materials. The inventive barrier film can advantageously be manufactured almost entirely from biobased materials, and preferably from cellulose based materials, thereby facilitating re-pulping and recycling of used paper and paperboard based packaging materials comprising the barrier film. Also, by minimizing the amount of coating (i.e. by enabling use of a low coat weight in accordance with the present disclosure), a barrier film is provided that is easier to recycle and reuse as part of the base web.

According to a second aspect of the present disclosure there is provided a barrier film obtainable by the method of the first aspect.

However, the inventive barrier film may also be utilized in a laminate together with one or more polymer layers, such as thermoplastic polymer layers.

According to a third aspect of the present disclosure, there is provided a method of producing a barrier film laminate, e.g. for a paper or paperboard based packaging material, comprising the barrier film obtainable by the method according to the first aspect, wherein the method comprises the steps of.
performing the method according to the first aspect so as to form said barrier film, and
laminating the barrier film with at least one additional polymer layer so as to form said barrier film laminate.

For example, the one or more additional polymer layers may be constituted by any suitable polyolefin, such as polyethylene, high-density polyethylene (HD-PE), low-density polyethylene (LD-PE), polypropylene, low-density polypropylene (LD-PP), biaxially-oriented polypropylene (BO-PP), polyethylene terephthalate (PET), etc. or mixtures or modifications thereof that could readily be selected by a skilled person.

The one or more additional polymer layer(s) may also be constituted by bio-derived or recyclable and/or compostable versions, such as polylactic acid (PLA), polyglycolic acid (PGA), polyhydroxyalkanoates (PHA), etc. The additional polymer layer(s) may comprise any of the thermoplastic polymers commonly used in paper or paperboard based packaging materials in general or polymers used in liquid packaging board in particular. Polyethylenes, especially low-density polyethylene (LDPE) and high-density polyethylene (HDPE), are the most common and versatile polymers used in liquid packaging board.

The additional polymer layer(s) can be provided e.g. by extrusion coating, film coating or dispersion coating. Extrusion coating is a process by which a molten plastic material is applied to a substrate to form a very thin, smooth and uniform layer. The coating can be formed by the extruded plastic itself, or the molten plastic can be used as an adhesive to laminate a solid plastic film onto the substrate. Common plastic resins used in extrusion coating include polyethylene (PE), polypropylene (PP), and polyethylene terephthalate (PET).

This laminate structure may provide for even more superior barrier properties and may be biodegradable and/or compostable and/or repulpable. In one embodiment, the barrier film according to the present invention can be provided between two coating layers, such as between two layers of polyethylene, with or without a tie layer.

The basis weight of each additional polymer layer is preferably 6-40 g/m², more preferably 8-30 g/m², most preferably 10-25 g/m².

In some embodiments, e.g. comprising one or more PE layers, the obtained barrier film laminate has a water vapor transmission rate (WVTR), measured according to the standard ASTM F1249 at 50% relative humidity and 23° C., of less than 5 g/m²/day, preferably less than 4 g/m²/day, more preferably less than 3 g/m²/day (for a coated side).

According to a fourth aspect of the present disclosure there is provided a barrier film laminate obtainable by the method of the third aspect.

According to a fifth aspect of the present disclosure there is provided a method of manufacturing a paper or paperboard based packaging material laminate, comprising the steps of:
performing the method according to the first aspect so as to form the barrier film or the method according to the third aspect so as to form the barrier film laminate, and
laminating the barrier film or the barrier film laminate with a paper or paperboard based base material so as to form said paper or paperboard based packaging material laminate.

The paper or paperboard base layer used in the paper or paperboard based packaging material may have a basis weight in the range of 20-500 g/m², preferably in the range of 80-400 g/m².

According to a sixth aspect of the present disclosure there is provided a paper or paperboard based packaging material laminate obtainable by the method according to the fifth aspect.

The barrier film or barrier film laminate can also be part of a flexible packaging material, such as a free-standing pouch or bag. The barrier film or barrier film laminate can be incorporated into any type of package, such as a box, bag, a wrapping film, cup, container, tray, bottle etc.

According to a seventh aspect of the present disclosure there is provided a barrier film comprising a coated substrate,
wherein said substrate comprises at least 70 weight-% highly refined cellulose pulp, wherein said highly refined cellulose pulp has a Schopper-Riegler value (°SR) of 70-95° SR, and wherein said highly refined cellulose pulp has a content of fibers having a length >0.2 mm of at least 10 million fibers per gram based on dry weight, wherein the substrate has a first side and a second opposite side,
wherein said substrate is provided with at least one first layer comprising:
d) a polymer selected from the group consisting of: a polyvinyl alcohol, a modified polyvinyl alcohol, a polysaccharide or a modified polysaccharide, or combinations thereof, or
e) a latex, or
f) a combination of d) and e),
on the first side, wherein each first layer has a coat weight of 0.5-5 gsm, preferably 0.5-3 gsm, calculated as dry weight, and wherein a total coat weight on the first side is equal to or less than 8 gsm calculated as dry weight;
wherein the barrier film a thickness of less than 50 μm, preferably less than 45 μm, most preferably less than 40 μm, and
wherein the barrier film has a water vapor transmission rate of less than 50 g/m²/day, preferably less than 35 g/m²/day, more preferably less than 20 g/m²/day, most preferably less than 15 g/m²/day, even more preferably less than 10 g/m²/day measured according to the standard ASTM F1249 at 50% relative humidity and 23° C.

The barrier film may be further defined as set out above with reference to the method of the first aspect.

According to an eighth aspect of the present disclosure there is provided a barrier film laminate comprising a barrier film according to the seventh aspect laminated with at least one additional polymer layer.

According to a ninth aspect of the present disclosure there is provided a paper or paperboard based packaging material comprising a barrier film according to the seventh aspect or a barrier film laminate according to the eighth aspect laminated with a paper or paperboard base material.

According to a tenth aspect of the present disclosure there is provided use of a barrier film according to the second aspect or the seventh aspect or a barrier film laminate according to the fourth aspect or the eighth aspect in a paper or paperboard based packaging material.

In view of the above detailed description of the present invention, other modifications and variations will become apparent to those skilled in the art. However, it should be apparent that such other modifications and variations may be effected without departing from the spirit and scope of the invention.

### EXAMPLES

### Methods

In the below Examples, the following measurement methods were used:
Water vapor transmission rate (WVTR) was measured according to the standard ASTM F1249 at 50% relative humidity and 23° C.
Oxygen transmission rate (OTR) was measured according to the standard ASTM D-3985 at 50% relative humidity and 23° C.
Grammage was determined according to ISO 536
PPS 1.0 MPa smoothness was determined according to ISO 8791-4
Air resistance (Gurley Hill, G-H) values were measured according to ISO 5636-5. Max value with the device was 42 300 s/100 m¹
Bendtsen roughness was determined according to ISO 8791-2
KIT values were measured according to standard ISO 16532-2
Schopper Riegler values (° SR) were measured according to standard ISO 5267-1
Opacity C/2°+UV and Opacity D65/10°+UV were determined according to ISO 2471
Thickness (single sheet) was determined according to ISO 534
Cobb600 (600 s) was determined according to ISO 535
Cobb-Unger 30 s. was determined according to SCAN-P 37:77
The content of fibers having a length >0.2 mm was determined using the L&W Fiber tester Plus instrument (L&W/ABB). A known sample weight of 0.100 g was used and the content of fibers having a length >0.2 mm (million fibers per gram) was calculated using the following formula: Million fibers per gram=(No. fibers in sample)/(Sample weight)/1000000=(Property ID 3141)/property ID 3136)/1000000
The mean fibril area was determined using the L&W Fiber Tester Plus instrument (L&W/ABB) with definition of fibers as fibrous particles longer than 0.2 mm according to standard ISO 16065-2. “Mean fibril area” as used herein refers to length weighted mean fibril area.
The water retention value (WRV) was determined by standard ISO 23714 with the use of a 200 mesh wire.

“ts” means top side and “bs” means back side

The results are shown in Tables 1 and 2 below.

### Example 1 (Comparative)

A commercial Supercalendered (SC) paper was used, without any further calendering or coating. The product has no barrier properties, but very low PPS 1.0 smoothness value.

### Example 2 (Comparative)

The commercial SC paper of Example 1 was PVOH (Poval 15-99) coated using a printing press (Flexography) using 2 coating stations with anilox rolls and with interim drying. The estimated total dry coat weight was 1.7 gsm. The results show a significant improvement in permeability and WVTR but grease resistance (KIT) remains low. No OTR value was measurable.

### Example 3 (Comparative)

This is a reference sample of a base film comprising 70 wt % highly refined pulp made from bleached kraft pulp and 30 wt % slightly refined pulp (°SR<30). The highly refined pulp had an SR value of 92-94°SR. The amount of fibers having length of >0.2 mm was slightly above 15 million per gram of fiber and the mean fibril area of fibers having a length >0.2 mm was about 25% for the highly refined pulp. The WRV for the highly refined pulp was about 380% and for the 70-30% mixture about 300%. The pulp mixture described above was used to prepare the base film using a Fourdrinier machine comprising a wet forming section followed by press and drying section. The sample has relatively high thickness when comparing with the commercial grade used in Example 1. Despite high amount of refined fibers, the PPS smoothness is relatively high. Oil and grease (KIT) barrier properties were good as well as the air permeability level (Gurley-Hill) whereas oxygen barrier properties (OTR) were poor and Cobb Unger value relatively high.

### Example 4 (Comparative)

This is the corresponding base film used in Example 3 but was super calendered at 140° C./300 kNm using a 11 nip set-up. The bulk was significantly reduced, as well as the opacity. However, the grease resistance (KIT) was changed from 12 to 6. Although pressure was further varied between 200-500 kNm and temperature between 110 and 150° C. and speed between 200 and 500 m/min, no significant changes in the oil and grease barrier properties or PPS smoothness were seen. The trials were performed by using steam (ca 5 g/m²) before calendering.

### Example 5

In this case, the base film used in Example 3 was soft calendered at 120° C. and 180 KN/m at a speed of 200 m/min using a 2 nip setup (hard-hard+hard-soft). The moisture content was approximately 4-5% in the calendering. Prior to the calendering nip, the web was steam treated in order to improve runnability. In this case, a substantial reduction in the bulk was seen, which is surprising, since super calender should be more efficient in densification of the substrate. What also is interesting is the reduction in opacity. Grease barrier (KIT) is on very good level, whereas OTR failed and WVTR is relatively high.

### Example 6

In this case, the hard-nip, soft-nip calendered sample according to Example 5 was one side coated with PVOH (Poval 15-99) at a coat weight of 1.5 gsm on the smoother side (hard-roll). Despite the low coat weight, the thickness was only changed by ca 15%. However, the Cobb Unger value was very low, indicating a very dense surface. Also, the WVTR value (for the coated side) was very low (14) confirming that the coating is providing barrier properties despite low coat weight.

### Example 7 (Comparative)

A new base film was prepared on a full scale machine using 70% highly refined pulp according to the same set up as described in Example 3. The grammage was 31.4 g/m².

### Example 8 (Comparative)

The base film made in Example 7 was now first coated at 120 m/min using the metering size press and 12 wt % PVOH (Poval 15-99) solution. The substrate was one side coated targeting a coat weight of 2.1 gsm. The obtained barrier properties (G-H, KIT and WVTR) were good except for OTR.

### Example 9

The sample obtained in Example 8 was further soft calendered (hard-hard+hard-soft nip, i.e. 2-nip setup) at 120° C. and 120 KN/m. The moisture content was approximately 4-5% in the calendering. A significant reduction in smoothness and roughness was obtained although the PPS smoothness differences between top and back side were more obvious compared to example 6. It further shows that for example Cobb Unger is not on same level as in Example 6, meaning that the use of the 2-nip calendering including a soft-nip is preferred before coating.

### Example 10

Sample from Example 5 was PE extrusion coated (about 25 gsm). The PE was extrusion coated on top of the smooth side. The WVTR value (for the coated side) was improved but OTR level was relatively high.

### Example 11

Sample from Example 6 was PE extrusion coated (about 25 gsm), i.e. on top of the PVOH layer. The WVTR value (for the coated side) was significantly improved as well as OTR properties.

### Example 12

Sample from Example 8 was PE extrusion coated (about 25 gsm), i.e. on top of the PVOH layer. The WVTR value (for the coated side) was significantly improved as well as OTR properties.

### Example 13

Sample from Example 9 was PE extrusion coated (about 25 gsm) on top of the 2-nip calendered PVOH layer. The WVTR value (for the coated side) was significantly improved as well as OTR properties.

### Example 14

The substrate of Example 3 comprising 70% of highly refined pulp was soft calendered (hard-hard+hard-soft) at 110° C. and then coated on the smooth side (top side) with an anilox using a flexography printing press. The moisture content was approximately 4-5% in the calendering. The coat weight was about 3 gsm of styrene-acrylate latex (S/A) latex applied in two layers (total 3 gsm). The sample was dried with IR dryers after each coating station (Temp of surface >85° C.).

### Example 15 (Comparative)

The same substrate as used in Example 14 was supercalandered using the 11-nip setup. The S/A emulsion was applied using a flexography printing press with two anilox stations. The applied amount was in total ca 3 gsm S/A latex on one side, i.e. applied in two layers. The results show that barrier properties were improved, whereas especially WVTR value was better for the Example 14.

TABLE 1

| | Example | | | | | | | | |
|---|---|---|---|---|---|---|---|---|---|
| | | | | | | 6 | | | 9 |
| | 1 | 2 | 3 | 4 | 5 | Soft + | 7 | 8 | MSP + |
| | K | K | Base | Super | Soft | MSP | Base | MSP | soft |
| Grammage | 50.9 | 52.3 | 30.8 | 29.5 | 31.3 | 32.3 | 31.4 | 33.5 | 33.8 |
| Soft caland, | — | — | — | — | Yes | — | | | |
| 120 C./180 | | | | | | | | | |
| KNm (200 | | | | | | | | | |
| m/min) | | | | | | | | | |
| Soft caland, | — | — | — | — | | — | | | Yes |
| 120 C./120 | | | | | | | | | |
| KNm (200 | | | | | | | | | |
| m/min) | | | | | | | | | |
| Super | — | — | — | yes | | — | | | |
| caland, 140 | | | | | | | | | |
| C./300 kNm | | | | | | | | | |
| MSP | — | — | — | — | — | 1.5 gsm | | 2.1 gsm | 2.1 gsm |
| coating, g/m² | | | | | | | | | |
| Flexo | — | 1.7 | | | | | | | |
| coating, g/m² | | | | | | | | | |
| Opacity C./2° + | 87.9 | 89 | 28.7 | 24.5 | 24.0 | 24.3 | 28.9 | 29.3 | 27.3 |
| UV ts | | | | | | | | | |
| Thickness | 46 | 48 | 45 | 31 | 28 | 32 | 46 | 50 | 35 |
| Gurley Hill, | 1026 | 42300 | 42300 | 43200 | 42300 | 42300 | 42300 | 42300 | 42300 |
| s/100 ml ts | | | | | | | | | |
| Bendtsen | 11 | 17 | 328 | 19 | 20 | 350 | 557 | 1266 | 237 |
| roughness | | | | | | | | | |
| ml/min ts | | | | | | | | | |
| Bendtsen | 15 | 17 | 481 | 17 | 33 | 308 | 833 | 1435 | 225 |
| roughness | | | | | | | | | |
| ml/min bs | | | | | | | | | |
| PPS | 1.0 | 1.5 | 5.9 | 2.5 | 2.7 | 3.2 | 5.7 | 6.0 | 3.6 |
| Smoothness | | | | | | | | | |
| 1.0 MPa, um | | | | | | | | | |
| ts | | | | | | | | | |
| PPS | 1.0 | 1.2 | 7.3 | 2.4 | 3.3 | 4.0 | 7.3 | 7.8 | 4.7 |
| Smoothness | | | | | | | | | |
| 1.0 MPa, um | | | | | | | | | |
| bs | | | | | | | | | |
| Cobb 10 min | 80.5 | 63 | 20.6 | 20.8 | 19.4 | 19.7 | 21.0 | 22.1 | 21.6 |
| ts | | | | | | | | | |
| Cobb 10 min | 74.7 | 64.9 | 20.8 | 20.5 | 19.6 | 18.8 | 20.6 | 22.4 | 22 |
| bs | | | | | | | | | |
| Cobb Unger | 4.6 | 0.6 | 4.0 | 1.3 | 1.2 | 1 | 2.9 | 2.7 | 1.5 |
| ts | | | | | | | | | |
| Cobb Unger | 5.2 | 5.9 | 3.8 | 0.8 | 0.9 | 1.2 | 2.8 | 3.2 | 2 |
| bs | | | | | | | | | |
| KIT | 0 | 6 | 12 | 6 | 12 | 12 | 11 | 12 | 12 |
| OTR, | fail | fail | fail | fail | fail | 874 | fail | 908 | 5421 |
| cc/m2/day | | | | | | | | | |
| (23 C./50% | | | | | | | | | |
| RH) | | | | | | | | | |
| WVTR, | | 41 | 197 | | 155 | 14 | 171 | 33 | 40 |
| g/m2/day | | | | | | | | | |
| (23 C./50% | | | | | | | | | |
| RH) | | | | | | | | | |

| Example | 10 | 11 | 12 | 13 |
|---|---|---|---|---|
| PE | | | | |
| lamination | | | | |
| OTR, | 56 | 10.2 | 9 | 9 |
| cc/m2/day | | | | |
| (23 C./50% | | | | |
| RH) | | | | |
| WVTR, | 2.0 | 1.4 | 1.5 | 1.6 |
| g/m2/day | | | | |
| (23 C./50% | | | | |
| RH) | | | | |

TABLE 2

| Example | 14 | 15 |
|---|---|---|
| Grammage | 36.1 | 35.4 |
| Soft caland, 110 C./180 | yes | |
| KNm (200 m/min) | | |
| Soft caland, 120 C./120 | | — |
| KNm (200 m/min) | | |
| Super calender, 80 C./300 kNm | | yes |
| Flexo coating, g/m² | 3 | 3 |
| Opacity C./2° + UV ts | 28.5 | 26.4 |
| Thickness | 40 | 38 |
| Gurley Hill, s/100 ml ts | 42 300 | 42 300 |
| Bendtsen roughness | 61 | 27 |
| ml/min ts | | |
| Bendtsen roughness | 225 | 220 |
| ml/min bs | | |
| PPS Smoothness 1.0 | 4.3 | 2.8 |
| MPa, um ts | | |
| PPS Smoothness 1.0 | 4.7 | 5.0 |
| MPa, um bs | | |
| Cobb 10 min ts | 23.7 | 22.4 |
| Cobb 10 min bs | 19.2 | 20.7 |
| Cobb Unger ts | 1.9 | 1.5 |
| Cobb Unger bs | 2.9 | 3.8 |
| KIT | 12 | 12 |
| OTR, cc/m2/day (23 C. / | fail | 1511 |
| 50% RH) | | |
| WVTR, g/m2/day (23 C. / | 16 | 37 |
| 50% RH) | | |

1. A method for manufacturing a barrier film, comprising the steps of:
providing an aqueous suspension comprising at least 70 weight-% highly refined cellulose pulp based on a total dry weight of the aqueous suspension, wherein said highly refined cellulose pulp has a Schopper-Riegler value of 70-95° SR, and wherein said highly refined cellulose pulp has a content of fibers having a length >0.2 mm of at least 10 million fibers per gram based on a dry weight;
forming a wet web from said aqueous suspension;
dewatering, or drying, or dewatering and drying said wet web to form a substrate having a first side and an opposite, second side;
calendering said substrate in at least one soft calender nip in a first calendering step, wherein said substrate has a moisture content of 1-25 weight-% when entering the first calendering step;
providing said substrate with at least one first layer of:
a) a water-based solution or dispersion comprising a polymer selected from a group consisting of: a polyvinyl alcohol, a modified polyvinyl alcohol, a polysaccharide, a modified polysaccharide, and combinations thereof, or
b) a water-based emulsion comprising a latex, or
c) a combination of a) and b),
on said first side in a first coating step to form a coated substrate, wherein each first layer has a coat weight of 0.5-5 gsm, calculated as a dry weight, and wherein a total coat weight on the first side is equal to or less than 8 gsm calculated as a dry weight, and
drying said coated substrate after said first calendering step and said first coating step so as to form said barrier film, wherein said barrier film has a thickness of less than 50 μm.

2. The method according to claim 1, wherein said first calendering step is performed before said first coating step.

3. The method according to claim 1, wherein said first coating step is performed before said first calendering step.

4. The method according to claim 1, wherein said soft calender nip comprises a soft roll and a hard roll, wherein said substrate is calendered between said soft roll and said hard roll in said first calendering step such that said first surface of said substrate is positioned against the hard roll and said second surface of said substrate is positioned against the soft roll.

5. The method according to claim 1, wherein said first calendering step comprises calendering said substrate in at least a first soft calender nip and a second soft calender nip.

6. The method according to claim 2, further comprising a second calendering step after said first coating step, wherein said second calendering step comprises calendering said coated substrate in at least one second calender selected from a soft calender, a hard calender, a belt calender or a super calender, and wherein said drying of said coated substrate is performed after said second calendering step.

7. The method according to claim 1, wherein a Gurley Hill porosity value of the substrate obtained in said step of dewatering, or drying, or dewatering and drying said wet web is at least 20000 s/100 ml.

8. The method according to claim 1, wherein said substrate is provided with at least one first layer of a water-based solution or dispersion comprising polyvinyl alcohol in the first coating step.

9. The method according to claim 1, wherein said substrate is provided with at least one first layer of a water-based emulsion comprising styrene-acrylate latex in the first coating step.

10. The method according to claim 1, further comprising providing said substrate with at least one second layer of said water-based solution or dispersion or said water-based emulsion on said second side in a second coating step, wherein each second layer has a coat weight of 0.5-5 gsm, calculated as a dry weight, wherein the total coat weight of said at least one first layer on the first side is equal to or less than 5 gsm calculated based on the dry weight and wherein a total coat weight of said at least one second layer on the second side is equal to or less than 5 gsm calculated as a dry weight, and wherein said drying of said coated substrate is performed after said second coating step.

11. The method according to claim 10, wherein said substrate is provided with at least one second layer of a water-based solution or dispersion comprising polyvinyl alcohol in the second coating step.

12. The method according to claim 10, wherein said substrate is provided with at least one second layer of a water-based emulsion comprising styrene-acrylate latex in the second coating step.

13. The method according to claim 10, wherein said first coating step and said second coating step are performed simultaneously.

14. The method according to claim 10, wherein said substrate obtained in said step of dewatering, or drying, or dewatering and drying said wet web has a density of 600-950 kg/m³.

15. The method according to claim 1, wherein a basis weight of said substrate obtained in the step of dewatering, or drying, or dewatering and drying is less than 90 g/m².

16. The method according to claim 1, further comprising pre-moisturizing said substrate prior to said first calendering step.

17. The method according to claim 1, wherein said first calendering step comprises using a line load of up to 500 kN/m.

18. The method according toe claim 1, wherein said first calendering step comprises using a temperature of 50-250° C., in said at least one soft calender nip.

19. The method according to claim 1, wherein the Cobb Unger absorption value of the barrier film is less than 1.5 g/m² (30 s) on said first side.

20. The method according to claim 1, wherein said highly refined cellulose pulp has a length weighted mean fibril area of fibers having a length >0.2 mm of at least 15%, determined using the L&W Fiber Tester Plus.

21. The method according to claim 1, wherein the wet web is a single or multilayer web made with one or several headboxes.

22. The method of claim 1 further comprising:
laminating said barrier film with at least one additional polymer layer so as to form a barrier film laminate.

23. The method of claim 22 further comprising:
laminating said barrier film or said barrier film laminate with a paper or paperboard base material so as to form a paper or paperboard based packaging material laminate.

24. (canceled)

25. (canceled)

26. (canceled)

27. A barrier film comprising a coated substrate,
wherein said substrate comprises at least 70 weight-% highly refined cellulose pulp, wherein said highly refined cellulose pulp has a Schopper-Riegler value (°SR) of 70-95°SR, and wherein said highly refined cellulose pulp has a content of fibers having a length >0.2 mm of at least 10 million fibers per gram based on a dry weight;
wherein said substrate has a first side and an opposite, second side;
wherein said substrate is provided with at least one first layer comprising:
d) a polymer selected from a group consisting of: a polyvinyl alcohol, a modified polyvinyl alcohol, a polysaccharide, a modified polysaccharide, and combinations thereof, or
e) a latex, or
f) a combination of d) and e),
on the first side, wherein each first layer has a coat weight of 0.5-5 gsm, calculated as a dry weight, and wherein a total coat weight on the first side is equal to or less than 8 gsm calculated as a dry weight;
wherein the barrier film a thickness of less than 50 μm, and
wherein the barrier film has a water vapor transmission rate of less than 50 g/m²/day.

28. The barrier film according to claim 27 further comprising: at least one additional polymer layer.

29. The barrier film according to claim 27 further comprising: a paper or paperboard base material.

30. (canceled)
